(19) United States
(12) Patent Application Publication
(10) Pub. No.: US 2002/0168442 A1
(43) Pub. Date: Nov. 14, 2002

(54) Multi-tip injection molding nozzle

(76) Inventors: Michael Gould, Essex Junction, VT (US); Edward Jenko, Essex Junction, VT (US)

Correspondence Address: Katten Muchin Zavis, 1025 Thomas Jefferson Street N.W., Suite 700 East Lobby, Washington, DC, 20007, US

(21) Appl. No.: 09/853,171

(22) Filed: May 10, 2001

(51) Int. Cl. B29C 45/22

(52) U.S. Cl. 425/549; 425/570

(57) ABSTRACT

An injection molding machine and injection nozzle having a plurality of nozzle tips affixed to a single nozzle bushing is shown.

### BACKGROUND OF THE INVENTION

1. Field of the Invention

This invention relates to injection molding nozzles. More particularly, this invention relates to a multi-tip injection-molding nozzle, which provides reduced pitch spacing between each nozzle tip.

2. Summary of the Prior Art

Injection molding is widely used for the manufacture of a variety of items, some of which have thin and delicate cross sections. These items can be molded in large quantities by using a single heated nozzle that extends into a single mold bore which feeds a number of mold cavities. These mold cavities typically have gates which extend through the mold block between the mold bore and the mold cavity, forming a melt flowpath to convey the injected melt from the bore to the mold cavities. Multi-tip nozzles are known in practice and serve in particular to enable relatively small parts to be molded in multiple injection molding molds in a narrow space in order that the multiple mold can be used as well as possible. The individual openings of the multi-tip nozzles can be so closely arranged relative to one another because of their common drive and their arrangement in a common housing so that even small workpieces and their mold cavities can be arranged in the multiple mold correspondingly close to one another.

As seen in U.S. Pat. No. 4,094,447, (incorporated herein by reference) a heated nozzle in which the melt passage branches outwardly to several edge gates is provided. While this is suitable for edge gating, each of the front portions of the nozzle has a flat face which is not suitable for hot tip gating.

U.S. Pat. No. 4,921,708 (incorporated herein by reference) shows a multi-gate application with hot tips provided by four elongated probes mounted around a heated nozzle. Other arrangements of multi-tip nozzles are also well known. However, they all require the use of a specially adapted nozzle bushing and take up more space than a typical single tip nozzle. In a system with a large number of gates, it is usually preferable to reduce overall size by having the gates as close together as possible.

Another previous construction of a heated multiple gate nozzle which directs the melt to multiple mold gates is shown in Canadian Pat. No. 976,314, (incorporated herein by reference) in which a multi-gate heater is disclosed having an intricately milled nozzle face with a series of convex openings formed therein.

Another construction such as that shown in U.S. Pat. No. 4,094,447 (incorporated herein by reference) relies in part on a specific configuration of the mold bore which includes a raised portion of the bore which is generally complementary to the heater nozzle face to fill much of the open area in the bore to cut down on the amount of heat transferred to the mold block during operation. Such approaches require costly machining of both the heater ends and mold bore.

### SUMMARY OF THE INVENTION

The primary objective of the present invention is to provide a multi-tip injection molding system with substantially smaller spacing between the tips of the nozzle.

Another object of the present invention is to provide a hot tip injection nozzle having an increased number of injection gates from a single nozzle body.

Still another object of the present invention is to provide a multi-tip plate that may be easily adapted to an existing injection nozzle.

Yet another object of the present invention is to provide a means for maximizing the available space of a mold by molding very small parts in a tightly packed arrangement.

The foregoing objects are achieved by providing an injection molding system that comprises a multi-tip injection molding nozzle. The multi-tip injection molding nozzle comprises a distribution plate with a plurality of nozzle tips affixed thereon. The distribution plate is rigidly affixed to a distal end of the injection nozzle. In this arrangement, a single nozzle assembly can provide a plurality of gates in a tightly spaced array for the production of large quantities of molded articles.

Further objects and advantages of the present invention will appear hereinbelow.

### BREIF DESCRIPTION OF THE DRAWINGS

FIG. 1 is a simplified cross-sectional view of an injection molding nozzle in accordance with the present invention;

FIG. 2 is a bottom plan view of the distribution plate having a plurality of nozzle tips;

FIG. 3 is a top plan view of the distribution plate showing a plurality of melt flow channels feeding a plurality of nozzle tips;

FIG. 3a is a simplified cross-sectional view of the distribution plate with the second melt channel being formed in the distribution plate;

FIG. 4 is a cross-sectional view of another preferred embodiment in accordance with the present invention where the distribution plate is formed integral to the retaining device for attachment to a nozzle;

FIG. 5 is a cross-sectional view of another preferred embodiment in accordance with the present invention where the distribution plate is formed integral to the retaining device for attachment to a nozzle;

FIG. 6 is a bottom plan view of the distribution plate that comprises threaded fasteners to affix the plate to a nozzle.

### DETAILED DESCRIPTION OF THE PREFERRED EMBODIMENTS

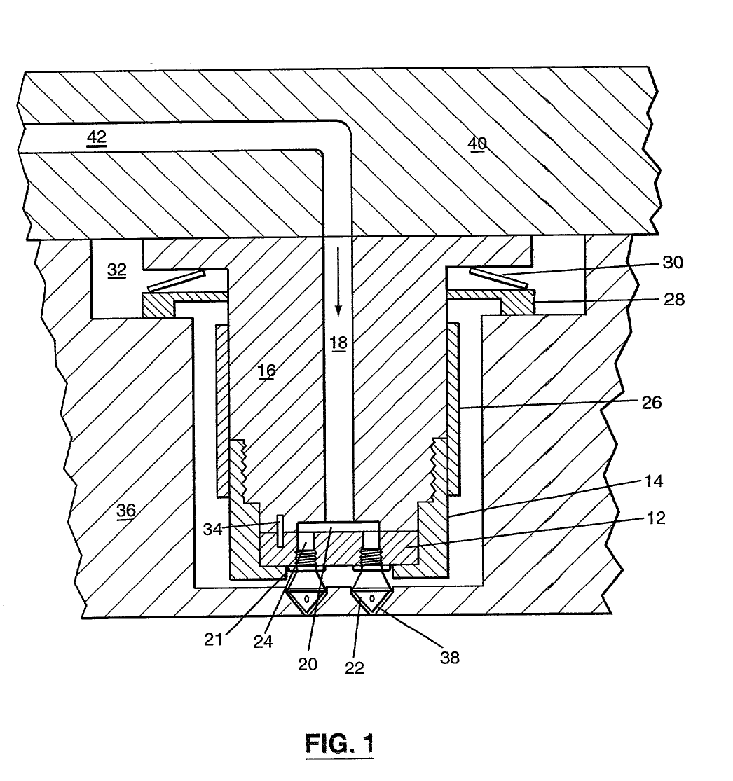

Referring first to FIG. 1, a simplified cross-sectional view of an injection nozzle in accordance with a preferred embodiment 10 of the present invention is generally shown. A nozzle bushing 16 is inserted into a cavity 32 of a manifold plate 36. An insulator 28 is provided in cavity 32 to support the nozzle bushing 16 thereby reducing thermal communication of nozzle bushing 16 to manifold plate 36. A spring 30 is inserted between nozzle bushing 16 and insulator 28 to provide a sealing force to resist leakage of molten material as it flows from a hot runner channel 42 of a hot runner manifold 40 to a first melt channel 18 running along a longitudinal axis of nozzle bushing 16.

Rigidly affixed to the lower distal end of nozzle bushing 16 by a fastener 14 is a distribution plate 12 for the communication of molten material from first melt channel 18 to a plurality of second melt channels 20. A plurality of nozzle tips 22 each preferably having a nut shaped portion 21, are rigidly affixed to distribution plate 12 adjacent a plurality of gates 38. An equal number of third melt channels 24 communicate the molten material from second melt channels 20 to each nozzle tip 22. The molten material is then communicated through each nozzle tip 22 to a respective gate 38 and then into a mold cavity (not shown) for the formation of a molded article.

Optionally, a locating device 34 is affixed between nozzle body 16 and distribution plate 12 to maintain the alignment of second melt channels 20 to third melt channels 24. A heater 26, well known in the art, is in thermal communication with the nozzle body 16 for maintaining the temperature of the molten material at a predetermined level.

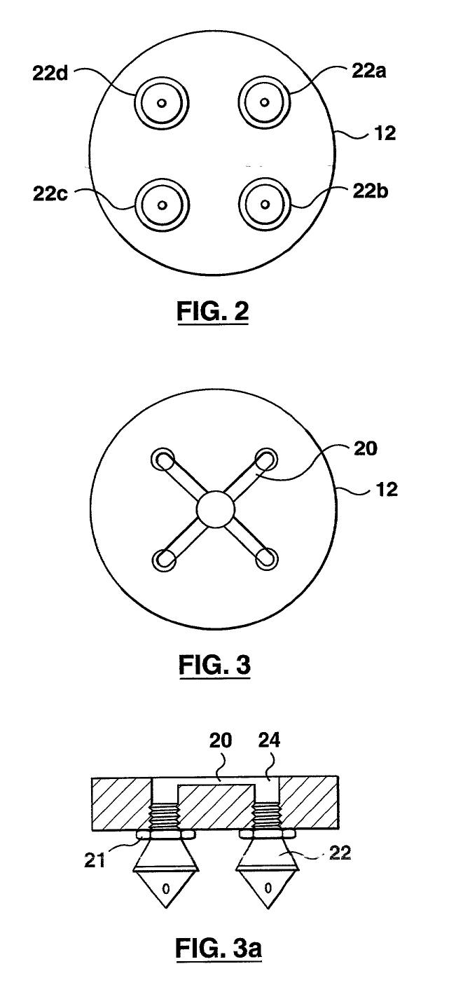

Referring to FIG. 2, a bottom view of distribution plate 12 is shown. A plurality of nozzle tips 22a-22d are rigidly affixed in a predetermined pattern to a bottom surface of distribution plate 12. In a preferred embodiment, the nozzle tip 22 is threaded into a threaded hole located in the distribution plate 12, but other suitable attachment means are also contemplated.

Referring now to FIGS. 3 and 3a, an alternate embodiment of the distribution plate 12 is shown where second melt channels 20 are formed integral to the distribution plate 12 rather than as part of the nozzle bushing 16. As shown, a plurality of second melt channels 20 extend from a central point of distribution plate 12 to each nozzle tip location. Using this arrangement, a given nozzle bushing 16 would not need to be replaced if the number of nozzle tips 22 were to be changed. Only the distribution plate 12 would need modification to accommodate a different number or layout of nozzle tips 22.

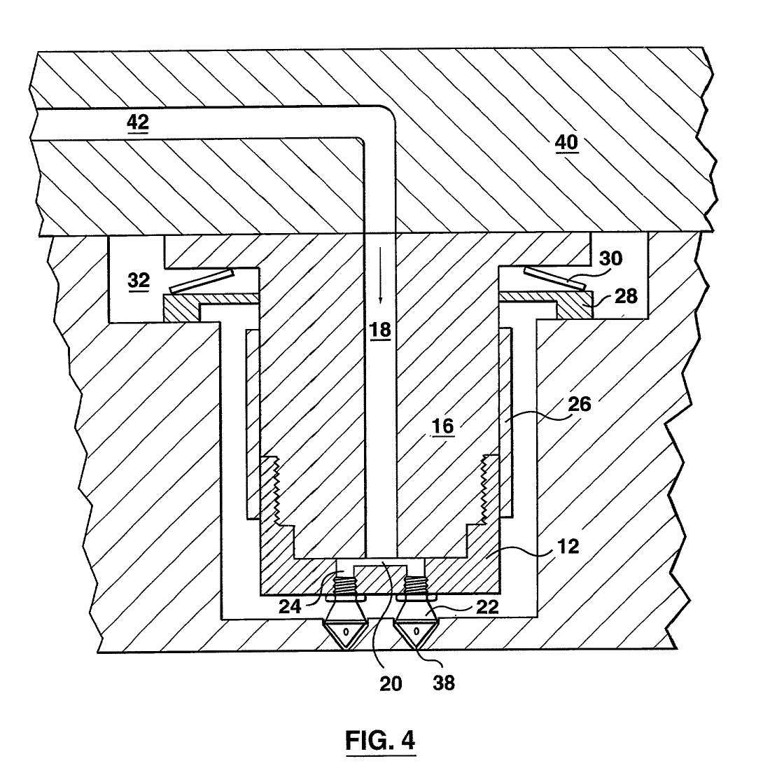

Referring now to FIG. 4, where like features have like numerals, an alternative embodiment according to the present invention is shown. In this embodiment, the distribution plate 12 comprises threads, so that it may be mounted on a distal end of the nozzle bushing 16 without the use of the previously described fastener 14. In this arrangement, the ability to align second melt channel 20 to third melt channels 24 has been eliminated, but if second melt channels 20 are formed in distribution plate 12 as shown in FIG. 3 and 3a, maintaining alignment is unnecessary.

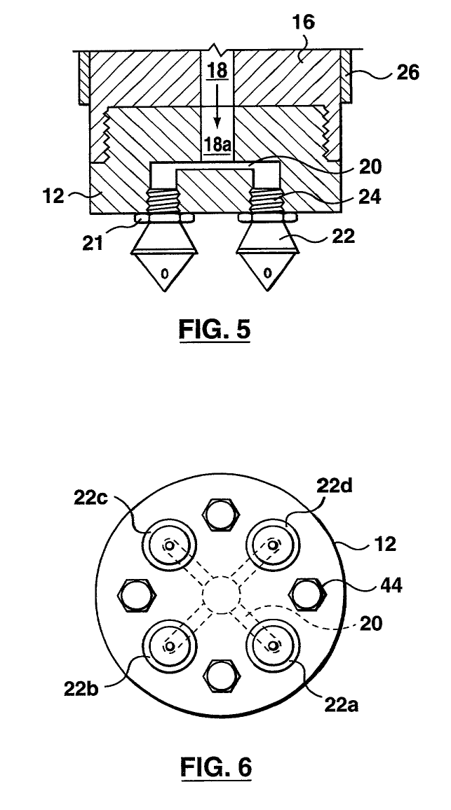

Referring now to FIG. 5, another preferred embodiment of the present invention is shown. In this embodiment, the configuration of the distribution plate 12 has been modified to comprise external threads at a top distal end for insertion into receiving threads located at a bottom distal end of nozzle bushing 16. A longitudinal melt channel 18a has been added to the distribution plate 12 to communicate the molten material from first melt channel 18 to second melt channel 20.

Referring to FIG. 6, yet another preferred embodiment of the present invention is shown. In this embodiment, the distribution plate 12 is mounted to nozzle bushing 16 by a plurality of threaded fasteners 44. Each fastener 44 is inserted into a threaded hole in the lower distal end of the nozzle bushing 16. The number of fasteners 44 required is determined by the sealing force required to preclude leakage of high pressure molten material between the distribution plate 12 and nozzle bushing 16.

It is to be understood that the invention is not limited to the illustrations described herein, which are deemed to illustrate the best modes of carrying out the invention, and which are susceptible to modification of form, size, arrangement of parts and details of operation. The invention is intended to encompass all such modifications, which are within its spirit and scope as defined by the claims.

What is claimed is:

1. In an injection molding system, an injection nozzle having a plurality of nozzle tips comprising an elongated nozzle bushing having at least one first melt channel formed therein, a distribution plate rigidly affixed to a distal end of said nozzle bushing, said distribution plate having at least one melt passageway formed therein that is substantially perpendicular to the longitudinal axis of said nozzle bushing, said at least one melt passageway in fluid communication with said first melt channel and further in fluid communication with a plurality of third melt channels, each of said third melt channels substantially perpendicular to said at least one melt passageway, each of said third melt channels in fluid communication with a respective each of said nozzle tips.

2. The injection nozzle of claim 1, wherein said at least one melt passageway is formed in said nozzle bushing.

3. The injection nozzle of claim 1, further comprising a heater in thermal communication with said nozzle bushing.

4. The injection nozzle of claim 1, wherein said distribution plate is rigidly affixed to said nozzle bushing by at least one threaded fastener.

5. The injection nozzle of claim 4, wherein said threaded fastener comprises a hollow body having internal threads for attachment to a distal end of said nozzle bushing and said threaded fastener fits around said distribution plate.

6. The injection nozzle of claim 5, wherein said hollow body comprises a seat which sealingly affixes said distribution plate to said nozzle bushing.

7. The injection nozzle of claim 5, wherein said hollow body has an external surface that is aligned with an external surface of said nozzle bushing.

8. The injection nozzle of claim 7, further comprising a heater in thermal communication with said hollow body and said nozzle bushing.

9. The injection nozzle of claim 1, wherein said nozzle tip is threaded into said distribution plate.

10. The injection nozzle of claim 1, wherein said nozzle tip is comprised of an internal piece and an external piece.

11. The injection nozzle of claim 10, wherein said internal piece and said external piece are made from two different material.

12. The injection nozzle of claim 10, wherein said internal piece is made of a material with a higher coefficient of thermal conductivity than said external piece.

13. The injection nozzle of claim 1, further comprising a locator between said nozzle bushing and said distribution plate for maintaining alignment of said melt channel with said first melt channel.

14. The injection nozzle of claim 1, wherein said distribution plate threads into an internally threaded seat of said nozzle bushing.

15. An injection molding machine for the formation of molded parts comprising:
a source for injecting molten material to a plurality of mold gates;
a runner system for communicating the flow of said molten material to at least one nozzle bushing adjacent said plurality of mold gates;
a distribution plate having a plurality of nozzle tips, said plate rigidly affixed to a distal end of said nozzle bushing and having at least one melt passageway formed therein that is substantially perpendicular to the longitudinal axis of said nozzle bushing, said at least one melt passageway in fluid communication with said first melt channel and further in fluid communication with a plurality of third melt channels, each of said third melt channels substantially perpendicular to said at least one melt passageway, each of said third melt channels in fluid communication with at least one said nozzle tip. The injection nozzle of claim 1, wherein said at least one melt passageway is formed in said nozzle bushing.

16. The injection molding machine of claim 15, further comprising a heater in thermal communication with said nozzle bushing.

17. The injection molding machine of claim 15, wherein said distribution plate is rigidly affixed to said nozzle bushing by at least one threaded fastener.

18. The injection molding machine of claim 17, wherein said threaded fastener comprises a hollow body having internal threads for attachment to a distal end of said nozzle bushing and said threaded fastener fits around said distribution plate.

19. The injection molding machine of claim 18, wherein said hollow body comprises a seat which sealingly affixes said distribution plate to said nozzle bushing.

20. The injection molding machine of claim 19, wherein said hollow body has an external surface that is aligned with an external surface of said nozzle bushing.

21. The injection molding machine of claim 19, further comprising a heater in thermal communication with said hollow body and said nozzle bushing.

22. The injection molding machine of claim 15, wherein said nozzle tip is threaded into said distribution plate.

23. The injection molding machine of claim 15, wherein said nozzle tip is comprised of an internal piece and an external piece.

24. The injection molding machine of claim 23, wherein said internal piece and said external piece are made from two different material.

25. The injection molding machine of claim 23, wherein said internal piece is made of a material with a higher coefficient of thermal conductivity than said external piece.

26. The injection molding machine of claim 15, further comprising a locator between said nozzle bushing and said distribution plate for maintaining alignment of said melt channel with said first melt channel.

27. The injection molding machine of claim 15, wherein said distribution plate threads into an internally threaded seat of said nozzle bushing.
